(19) United States
(12) Patent Application Publication
(10) Pub. No.: US 2025/0110238 A1
(43) Pub. Date: Apr. 3, 2025

(54) DEVICE AND METHOD FOR SHOE AND/OR FOOT SCANNING WITH COMBINED ELECTROMAGNETIC WAVE AND INDUCTIVE SCANNING CAPABILITIES

(71) Applicant: Rohde & Schwarz GmbH & Co. KG, Munich (DE)

(72) Inventors: Julian LANDESBERGER, Munich (DE); Gilles SANTI, Lausanne (CH); Beryl YERSIN, Echallens (CH)

(73) Assignee: Rohde & Schwarz GmbH & Co. KG, Munich (DE)

(21) Appl. No.: 18/477,740

(22) Filed: Sep. 29, 2023

(51) Int. Cl. G01S 17/04; G01S 7/481; G01S 17/89

(52) U.S. Cl. CPC G01S 17/04; G01S 7/4813; G01S 17/89

(57) ABSTRACT

A shoe and/or foot scanner combining electromagnetic wave and inductive scanning capabilities is provided. Said shoe and/or foot scanner comprises at least one electromagnetic wave sensor, at least one inductive sensor, and a control unit. In this context, the at least one electromagnetic wave sensor and the at least one inductive sensor are arranged such that the at least one electromagnetic wave sensor and the at least one inductive sensor have at least one overlapping detection volume and/or area. In addition to this, the control unit is configured to evaluate the corresponding sensor measurements from the at least one electromagnetic wave sensor and the at least one inductive sensor for at least a part or each of the at least one overlapping detection volume and/or area to determine an overall threat probability.

### TECHNICAL FIELD

The disclosure relates to a shoe and/or foot scanner combining electromagnetic wave and inductive scanning capabilities, and a method for shoe and/or foot scanning, the method combining electromagnetic wave and inductive scanning capabilities.

### BACKGROUND ART

Generally, in times of an increasing number of security areas or people passing such areas, respectively, there is a growing need of a shoe and/or foot scanner combining electromagnetic wave and inductive scanning capabilities, and a method for shoe and/or foot scanning, said method combining electromagnetic wave and inductive scanning capabilities, for particularly reliable and efficient scanning especially to prevent threats.

U.S. Pat. No. 10,641,890 B2 discloses a detector device for detection of unauthorized objects or substances. Said detector device includes a support base designed to receive at least one foot covered by its shoe, of an individual to be controlled. Furthermore, the detector device also includes a mechanism to measure the electrical capacity of the sole of a shoe placed on the support base. Said electrical capacity can be used to determine a height of said sole of the shoe. In addition to this, microwave means can be used to detect stratification by vertical stacking in the sole by detection of successive echoes following emission of waves towards the sole.

Disadvantageously, especially by separately performing measurements with respect to said electrical capacity and with the aid of said microwave means, inconclusive measurement results cannot automatically be corrected or made conclusive, respectively, thereby lacking not only reliability but also efficiency.

### SUMMARY

Thus, there is a need to provide a shoe and/or foot scanner combining electromagnetic wave and inductive scanning capabilities, and a method for shoe and/or foot scanning, said method combining electromagnetic wave and inductive scanning capabilities, for particularly reliable and efficient scanning especially to prevent threats.

This is achieved by the embodiments provided in the enclosed independent claims. Advantageous implementations of the present disclosure are further defined in the dependent claims.

According to a first aspect of the present disclosure, a shoe and/or foot scanner combining electromagnetic wave and inductive scanning capabilities is provided. Said shoe and/or foot scanner comprises at least one electromagnetic wave sensor, at least one inductive sensor, and a control unit. In this context, the at least one electromagnetic wave sensor and the at least one inductive sensor are arranged such that the at least one electromagnetic wave sensor and the at least one inductive sensor have at least one overlapping detection volume and/or area. In addition to this, the control unit is configured to evaluate the corresponding sensor measurements from the at least one electromagnetic wave sensor and the at least one inductive sensor for at least a part or each of the at least one overlapping detection volume and/or area to determine an overall threat probability. Advantageously, a particularly reliable and efficient scanning can be ensured especially to prevent threats.

Further advantageously, with respect to the above-mentioned term “combining electromagnetic wave and inductive scanning capabilities”, it is noted that said term can especially be understood as not merely aggregating data measured by the at least one electromagnetic wave sensor and the at least one inductive sensor especially in retrospect or after measuring, respectively. Quite the contrary, the above-mentioned term “combining electromagnetic wave and inductive scanning capabilities” may especially be understood as fusing the corresponding sensors by physical superposition especially in advance or before measuring, respectively.

Accordingly, the shoe and/or foot scanner combining electromagnetic wave and inductive scanning capabilities may be a shoe and/or foot scanner combining electromagnetic wave and inductive scanning capabilities especially by physical superposition preferably in the sense of a fusion of the corresponding sensors.

According to an implementation form of the first aspect of the present disclosure, the control unit is configured to decide whether there is an alarm to be reported based on the overall threat probability. Advantageously, for instance, security personnel can focus on other tasks than reporting alarms in the presence of a threat, thereby increasing efficiency.

According to a further implementation form of the first aspect of the present disclosure, the control unit is configured to determine at least one individual threat probability based on the corresponding sensor measurements from the at least one electromagnetic wave sensor. Advantageously, for example, the at least one individual threat probability can additionally be taken in account in the context of determining the overall threat probability, thereby increasing reliability and efficiency.

According to a further implementation form of the first aspect of the present disclosure, the control unit is configured to determine at least one further individual threat probability based on the corresponding sensor measurements from the at least one inductive sensor. Advantageously, for instance, the at least one further individual threat probability can additionally be taken in account in the context of determining the overall threat probability, which leads to an increased reliability and efficiency.

According to a further implementation form of the first aspect of the present disclosure, if at least a part or each of the at least one individual threat probability is inconclusive, the control unit is configured to combine at least the part or each of the at least one individual threat probability with at least a part or each of at least one further individual threat probability based on the corresponding sensor measurements from the at least one inductive sensor especially to get at least one conclusive threat probability. Advantageously, for example, inconclusive results with respect to the at least one electromagnetic wave sensor does not necessarily lead to the need for manual investigations through security personnel, thereby increasing efficiency.

According to a further implementation form of the first aspect of the present disclosure, if at least a part or each of the at least one further individual threat probability is inconclusive, the control unit is configured to combine at least the part or each of the at least one further individual threat probability with at least a part or each of at least one individual threat probability based on the corresponding sensor measurements from the at least one electromagnetic wave sensor especially to get at least one further conclusive threat probability. Advantageously, for instance, inconclusive results with respect to the at least one inductive sensor does not necessarily lead to the need for manual investigations through security personnel, thereby increasing efficiency.

According to a further implementation form of the first aspect of the present disclosure, the control unit is configured to use machine learning and/or artificial intelligence and/or at least one artificial neural network to identify the correspondingly scanned object and/or materials especially based on the corresponding sensor measurements from the at least one electromagnetic wave sensor and/or the at least one inductive sensor. Advantageously, for example, object and/or materials identification can efficiently be implemented in a self-improving manner.

According to a further implementation form of the first aspect of the present disclosure, the control unit is configured to infer an amount of metal and/or shape with respect to the correspondingly scanned object and/or materials especially based on the corresponding sensor measurements from the at least one electromagnetic wave sensor and/or the at least one inductive sensor. Advantageously, for instance, the amount of metal and/or shape can be used for increasing not only reliability but also efficiency in the context of determining the overall threat probability.

According to a further implementation form of the first aspect of the present disclosure, the control unit is configured to correlate the amount of metal and shape with respect to the correspondingly scanned object and/or materials especially by using machine learning and/or artificial intelligence and/or at least one artificial neural network preferably to identify the correspondingly scanned object and/or materials. Advantageously, for example, the identification of threatful objects can be designed in a self-improving manner.

According to a further implementation form of the first aspect of the present disclosure, at least a part or each of the at least one electromagnetic wave sensor comprises or is at least one millimeter-wave transceiver. In addition to this or as an alternative, at least a part or all of the at least one electromagnetic wave sensor forms a millimeter-wave transceiver array or a millimeter-wave panel. Advantageously, for instance, the at least one electromagnetic wave sensor can form two millimeter-wave panels being opposite with respect to each other.

According to a further implementation form of the first aspect of the present disclosure, at least a part or each of the at least one inductive sensor comprises or is at least one coil, especially at least one metal detection coil. Advantageously, for example, complexity can be reduced, which leads to an increased efficiency.

According to a further implementation form of the first aspect of the present disclosure, the control unit comprises or is a controller or an application-specific integrated circuit, especially an application-specific integrated circuit acquisition unit. Advantageously, for instance, inefficiencies can be reduced by increasing simplicity.

According to a further implementation form of the first aspect of the present disclosure, the shoe and/or foot scanner is used in the context of security areas such as airport security. Advantageously, for example, the shoe and/or foot scanner can also be used in the context of loss prevention, protection of restricted areas, or border customs.

According to a second aspect of the present disclosure, a method for shoe and/or foot scanning, the method combining electromagnetic wave and inductive scanning capabilities is provided. Said method comprises the steps of arranging at least one electromagnetic wave sensor and at least one inductive sensor such that the at least one electromagnetic wave sensor and the at least one inductive sensor have at least one overlapping detection volume and/or area, and evaluating the corresponding sensor measurements from the at least one electromagnetic wave sensor and the at least one inductive sensor for at least a part or each of the at least one overlapping detection volume and/or area to determine an overall threat probability especially with the aid of a control unit. Advantageously, a particularly reliable and efficient scanning can be ensured especially to prevent threats.

Further advantageously, with respect to the above-mentioned term “combining electromagnetic wave and inductive scanning capabilities”, it is noted that said term can especially be understood as not merely aggregating data measured by the at least one electromagnetic wave sensor and the at least one inductive sensor especially in retrospect or after measuring, respectively. Quite the contrary, the above-mentioned term “combining electromagnetic wave and inductive scanning capabilities” may especially be understood as fusing the corresponding sensors by physical superposition especially in advance or before measuring, respectively.

Accordingly, the method for shoe and/or foot scanning, the method combining electromagnetic wave and inductive scanning capabilities may be a method for shoe and/or foot scanning, said method combining electromagnetic wave and inductive scanning capabilities especially by physical superposition preferably in the sense of a fusion of the corresponding sensors.

Before some implementation forms of the second aspect of the present disclosure are explained in the following, it is noted that for implementation form behaving analogously with respect to the above-mentioned implementation forms of the first aspect of the present disclosure, the respective advantages as described above analogously apply. In addition to this, all the implementation forms according to the first aspect of the present disclosure analogously apply for the second aspect of the present disclosure, and vice versa, especially in the case that corresponding implementation form is not explicitly discussed within the scope of the first aspect or the second aspect, respectively.

According to an implementation form of the second aspect of the present disclosure, the method further comprises the step of deciding whether there is an alarm to be reported based on the overall threat probability especially with the aid of the control unit.

According to a further implementation form of the second aspect of the present disclosure, the method further comprises the step of determining at least one individual threat probability based on the corresponding sensor measurements from the at least one electromagnetic wave sensor especially with the aid of the control unit.

According to a further implementation form of the second aspect of the present disclosure, the method further comprises the step of determining at least one further individual threat probability based on the corresponding sensor measurements from the at least one inductive sensor especially with the aid of the control unit.

According to a further implementation form of the second aspect of the present disclosure, the method further comprises the step of if at least a part or each of the at least one individual threat probability is inconclusive, preferably with the aid of the control unit, combining at least the part or each of the at least one individual threat probability with at least a part or each of at least one further individual threat probability based on the corresponding sensor measurements from the at least one inductive sensor especially to get at least one conclusive threat probability.

According to a further implementation form of the second aspect of the present disclosure, the method further comprises the step of if at least a part or each of the at least one further individual threat probability is inconclusive, preferably with the aid of the control unit, combining at least the part or each of the at least one further individual threat probability with at least a part or each of at least one individual threat probability based on the corresponding sensor measurements from the at least one electromagnetic wave sensor especially to get at least one further conclusive threat probability.

According to a further implementation form of the second aspect of the present disclosure, the method further comprises the step of preferably with the aid of the control unit, using machine learning and/or artificial intelligence and/or at least one artificial neural network to identify the correspondingly scanned object and/or materials especially based on the corresponding sensor measurements from the at least one electromagnetic wave sensor and/or the at least one inductive sensor.

### BRIEF DESCRIPTION OF THE DRAWINGS

The above-described aspects and implementation forms of the present disclosure will be explained in the following description of specific embodiments in relation to the enclosed drawings, in which:

FIG. 1 shows an exemplary embodiment of the first aspect of the present disclosure;

FIG. 2A shows a first exemplary embodiment of an inductive sensor field;

FIG. 2B shows a second exemplary embodiment of an inductive sensor field;

FIG. 2C shows a third exemplary embodiment of an inductive sensor field; and

FIG. 3 shows a flow chart of an exemplary embodiment of the second aspect of the present disclosure.

### DETAILED DESCRIPTIONS OF EMBODIMENTS

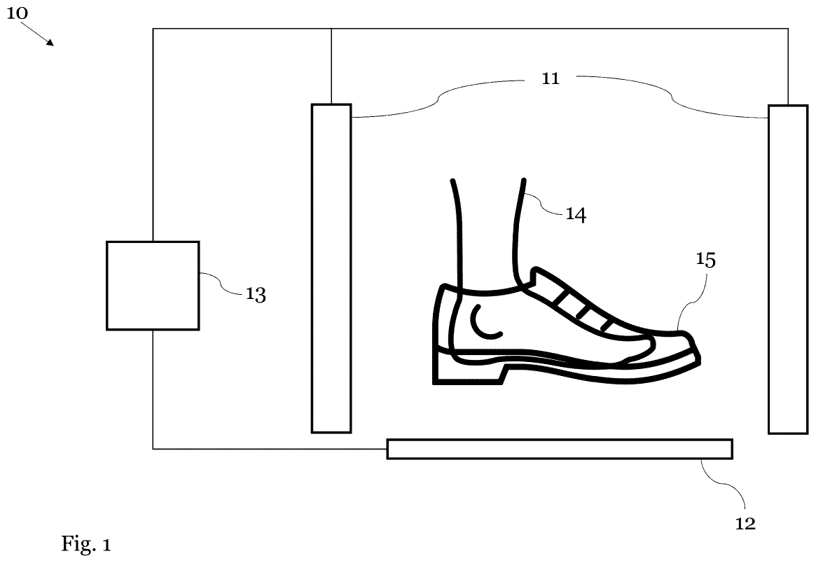

With respect to FIG. 1, an exemplary embodiment of the shoe and/or foot scanner 10 combining electromagnetic wave and inductive scanning capabilities according to the first aspect of the present disclosure is depicted.

In accordance with said FIG. 1, the shoe and/or foot scanner 10 comprises at least one electromagnetic wave sensor, exemplarily an electromagnetic wave sensor field 11, at least one inductive sensor, exemplarily an inductive sensor field 12, and a control unit 13 connected to the at least one electromagnetic wave sensor or the electromagnetic sensor field 11, respectively, and the at least one inductive sensor or the inductive sensor field 12, respectively.

In this context, the at least one electromagnetic wave sensor or the electromagnetic wave sensor field 11, respectively, and the at least one inductive sensor or the inductive sensor field 12, respectively, are arranged such that the at least one electromagnetic wave sensor or the electromagnetic wave sensor field 11, respectively, and the at least one inductive sensor or the inductive sensor field 12, respectively, have at least one overlapping detection volume and/or area.

In addition to this, the control unit 13 is configured to evaluate the corresponding sensor measurements from the at least one electromagnetic wave sensor or the electromagnetic wave sensor field 11, respectively, and the at least one inductive sensor or the inductive sensor field 12, respectively, for at least a part or each of the at least one overlapping detection volume and/or area to determine an overall threat probability.

As it can further be seen from FIG. 1, the shoe and/or foot scanner 10 is adapted to scan and/or investigate at least one of a foot 14, a shoe 15, the foot 14 wearing the shoe 15, a part of a leg, especially a part of a lower leg or a lower leg, at least one further part of a human body, a human body, or any combination thereof.

Furthermore, with respect to the above-mentioned at least one overlapping detection volume and/or area, it is noted that said at least one overlapping detection volume and/or area may exemplarily comprise at least one of the foot 14, a part of the foot 14, the shoe 15, a part of the shoe 15, the foot 14 wearing the shoe 15, a part of the foot 14 wearing the shoe 15, a part of a leg, especially a part of a lower leg or a lower leg, at least one further part of a human body, a human body, or any combination thereof.

It is further noted that it might be particularly advantageous if the control unit 13 is configured to decide whether there is an alarm to be reported based on the overall threat probability.

Additionally or alternatively, the control unit 13 may be configured to determine at least one individual threat probability based on the corresponding sensor measurements from the at least one electromagnetic wave sensor or the electromagnetic wave sensor field 11, respectively.

For instance, the control unit 13 may be configured to analyze the data measured with the aid of the at least one electromagnetic wave sensor or the electromagnetic wave sensor field 11, respectively, for possible threats and compare it against a first individual threshold.

In further addition or as a further alternative, the control unit 13 may be configured to determine at least one further individual threat probability based on the corresponding sensor measurements from the at least one inductive sensor or the inductive sensor field 12, respectively.

For example, the control unit 13 may be configured to analyze the data measured with the aid of the at least one inductive sensor or the inductive sensor field 12, respectively, for possible threats and compare it against a second individual threshold.

It is noted that it might be particularly advantageous if the control unit 13 is configured to show up a threat in a correspondingly aggregated result if the threat surpasses the first individual threshold and/or the second individual threshold.

With respect to the aggregated result, it is noted that said aggregated result may comprise the corresponding analysis result with respect to the at least one electromagnetic wave sensor or the electromagnetic wave sensor field 11, respectively, and/or the at least one inductive sensor or the inductive sensor field 12, respectively.

Furthermore, if at least a part or each of the at least one individual threat probability is inconclusive, the control unit 13 may be configured to combine at least the part or each of the at least one individual threat probability with at least a part or each of at least one further individual threat probability based on the corresponding sensor measurements from the at least one inductive sensor or the inductive sensor field 12, respectively, especially to get at least one conclusive threat probability.

Moreover, if at least a part or each of the at least one further individual threat probability is inconclusive, the control unit 13 may be configured to combine at least the part or each of the at least one further individual threat probability with at least a part or each of at least one individual threat probability based on the corresponding sensor measurements from the at least one electromagnetic wave sensor or the electromagnetic wave sensor field 11, respectively, especially to get at least one further conclusive threat probability.

For instance, certain threats will, however, neither surpass the above-mentioned first individual threshold nor the above-mentioned second individual threshold. In this case, the measured information by each of the at least one electromagnetic wave sensor or the electromagnetic wave sensor field 11, respectively, and the at least one inductive sensor or the inductive sensor field 12, respectively, is inconclusive on its own. Advantageously, combining the information gathered by each the at least one electromagnetic wave sensor or the electromagnetic wave sensor field 11, respectively, and the at least one inductive sensor or the inductive sensor field 12, respectively, allows to detect such threats. Where the possible threat locations coincide, without passing said thresholds individually, the combined analysis can determine a threat and preferably report a detection.

It is noted that it might be particularly advantageous if the control unit 13 is configured to use machine learning and/or artificial intelligence and/or at least one artificial neural network to identify the correspondingly scanned object and/or materials especially based on the corresponding sensor measurements from the at least one electromagnetic wave sensor or the electromagnetic wave sensor field 11, respectively, and/or the at least one inductive sensor or the inductive sensor field 12, respectively.

It is further noted that it might be particularly advantageous if the control unit 13 is configured to infer an amount of metal and/or shape with respect to the correspondingly scanned object and/or materials especially based on the corresponding sensor measurements from the at least one electromagnetic wave sensor or the electromagnetic wave sensor field 11, respectively, and/or the at least one inductive sensor or the inductive sensor field 12, respectively.

In this context, the control unit 13 may be configured to correlate the amount of metal and shape with respect to the correspondingly scanned object and/or materials especially by using machine learning and/or artificial intelligence and/or at least one artificial neural network preferably to identify the correspondingly scanned object and/or materials.

With respect to the at least one electromagnetic wave sensor, it is noted that at least a part or each of the at least one electromagnetic wave sensor may comprise or be at least one millimeter-wave transceiver. Accordingly, the electromagnetic wave sensor field 11 may comprise at least one millimeter-wave transceiver, preferably multiple millimeter-wave transceivers, more preferably multiple millimeter-wave transceivers arranged according to a certain pattern, most preferably multiple millimeter-wave transceivers arranged according to a chessboard pattern.

In addition to this or as an alternative, at least a part or all of the at least one electromagnetic wave sensor may form a millimeter-wave transceiver array or a millimeter-wave panel. Accordingly, the electromagnetic wave sensor field 11 may comprise or be a millimeter-wave transceiver array or a millimeter-wave panel.

With respect to the at least one inductive sensor, it is noted that at least a part or each of the at least one inductive sensor may comprise or be at least one coil, especially at least one metal detection coil. Accordingly, the inductive sensor field 12 may comprise at least one coil, especially at least one metal detection coil, preferably multiple coils or multiple metal detection coils, more preferably multiple coils arranged according to a certain pattern or multiple metal detection coils arranged according to a certain pattern, most preferably multiple coils arranged according to a chessboard pattern or multiple metal detection coils arranged according to a chessboard pattern.

With respect to the control unit 13, it is noted that it might be particularly advantageous if the control unit 13 comprises or is a controller or an application-specific integrated circuit, especially an application-specific integrated circuit acquisition unit.

Again, with respect to the at least one electromagnetic wave sensor or the electromagnetic wave sensor field 11, respectively, it is noted that it might be particularly advantageous if the at least one electromagnetic wave sensor or the electromagnetic wave sensor field 11, respectively, is arranged such that the corresponding sole of the foot 14 to be scanned and/or the corresponding sole of the shoe 15 to be scanned is perpendicular or substantially perpendicular to the at least one electromagnetic wave sensor or the electromagnetic wave sensor field 11, respectively.

With respect to the above-mentioned term “substantially perpendicular”, it is noted that said term can especially be understood as a deviation of not more than 30 degrees, preferably not more than 20 degrees, more preferably not more than 10 degrees, most preferably not more than 5 degrees, from 90 degrees.

Again, with respect to the at least one inductive sensor or the inductive sensor field 12, respectively, it is noted that it might be particularly advantageous if the at least one inductive sensor or the inductive sensor field 12, respectively, is arranged such that the corresponding sole of the foot 14 to be scanned and/or the corresponding sole of the shoe 15 to be scanned is parallel or substantially parallel to the at least one inductive sensor or the inductive sensor field 12, respectively.

With respect to the above-mentioned term “substantially parallel”, it is noted that said term can especially be understood as a deviation of not more than 30 degrees, preferably not more than 20 degrees, more preferably not more than 10 degrees, most preferably not more than 5 degrees, from 0 degree.

Moreover, with respect to the at least one electromagnetic wave sensor or the electromagnetic wave sensor field 11, respectively, and the at least one inductive sensor or the inductive sensor field 12, respectively, it is noted that it might be particularly advantageous if the at least one electromagnetic wave sensor or the electromagnetic wave sensor field 11, respectively, and the at least one inductive sensor or the inductive sensor field 12, respectively, are arranged in a perpendicular or substantially perpendicular manner with respect to each other.

With respect to the above-mentioned term “substantially perpendicular”, it is noted that said term can especially be understood as a deviation of not more than 30 degrees, preferably not more than 20 degrees, more preferably not more than 10 degrees, most preferably not more than 5 degrees, from 90 degrees.

Furthermore, with respect to the shoe and/or foot scanner 10, it is noted that it might be particularly advantageous if the shoe and/or foot scanner 10 is used in the context of security areas such as airport security, loss prevention, protection of restricted areas, or border customs.

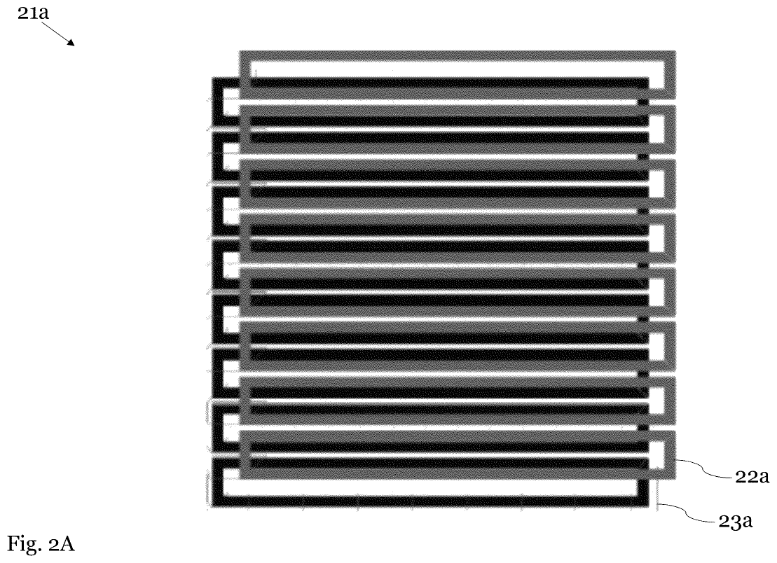

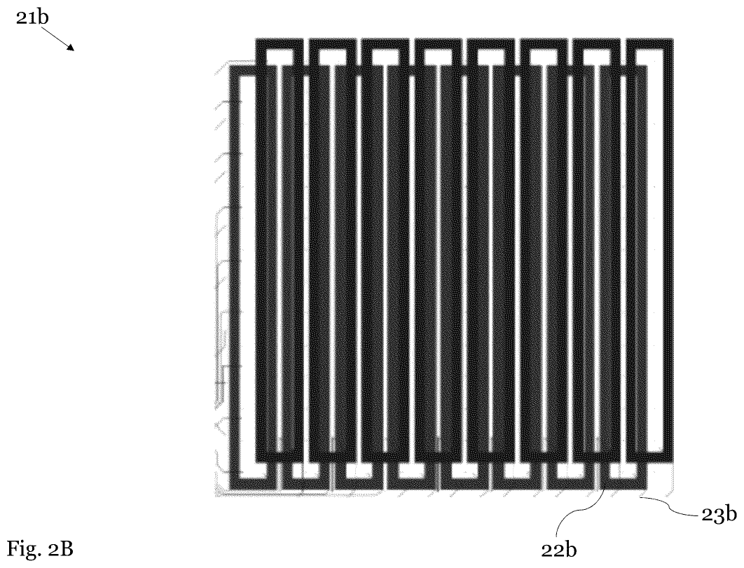

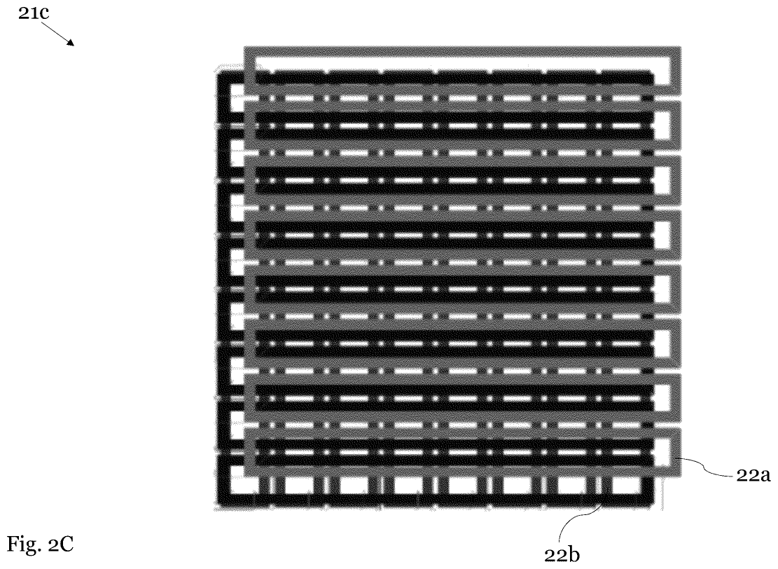

Again, with respect to the at least one inductive sensor or the inductive sensor field 12, respectively, it is noted that three exemplary embodiments thereof are illustrated by FIG. 2A, FIG. 2B, and FIG. 2C.

In accordance with the first exemplary embodiment 21a of FIG. 2A, said first exemplary embodiment 21a comprises a first multitude of coils, wherein one of said coils is representatively equipped with reference sign 22a.

At least a part or each of the coils of said first multitude is oriented according to a first direction, especially a horizontal direction or x-direction. Furthermore, the first exemplary embodiment 21a exemplarily comprises a feeding structure especially for connecting the first multitude of coils to the above-mentioned control unit 13, wherein a part of said feeding structure is representatively equipped with reference sign 23a.

It is noted that it might be particularly advantageous if the first multitude of coils is integrated into a plate or a mat or any kind thereof especially for being stepped on. It is further noted that any kind of a covered cavity especially for being stepped on can comprise the first multitude of coils or at least a part thereof.

Moreover, in accordance with the second exemplary embodiment 21b of FIG. 2B, said second exemplary embodiment 21b comprises a second multitude of coils, wherein one of said coils is representatively equipped with reference sign 22b.

At least a part or each of the coils of said second multitude is oriented according to a second direction, especially a vertical direction or y-direction. Furthermore, the second exemplary embodiment 21b exemplarily comprises a feeding structure especially for connecting the second multitude of coils to the above-mentioned control unit 13, wherein a part of said feeding structure is representatively equipped with reference sign 23b.

By analogy with the first exemplary embodiment 21a of FIG. 2A, it is noted that it might be particularly advantageous if the second multitude of coils is integrated into a plate or a mat or any kind thereof especially for being stepped on. It is further noted that any kind of a covered cavity especially for being stepped on can comprise the second multitude of coils or at least a part thereof.

Furthermore, the third exemplary embodiment 21c according to FIG. 2C is based the first exemplary embodiment 21a of FIG. 2A and the second exemplary embodiment 21b of FIG. 2B, wherein the first multitude of coils and the second multitude of coils are superimposed or stacked especially on top of one another. Accordingly, the explanations above regarding FIG. 2A and FIG. 2B can analogously apply.

It is noted that it might be particularly advantageous if the first direction regarding the part or each of the coils of the first multitude and the second direction regarding the part or each of the coils of the second multitude are arranged in a perpendicular or substantially perpendicular manner with respect to each other.

With respect to the above-mentioned term “substantially perpendicular”, it is noted that said term can especially be understood as a deviation of not more than 30 degrees, preferably not more than 20 degrees, more preferably not more than 10 degrees, most preferably not more than 5 degrees, from 90 degrees.

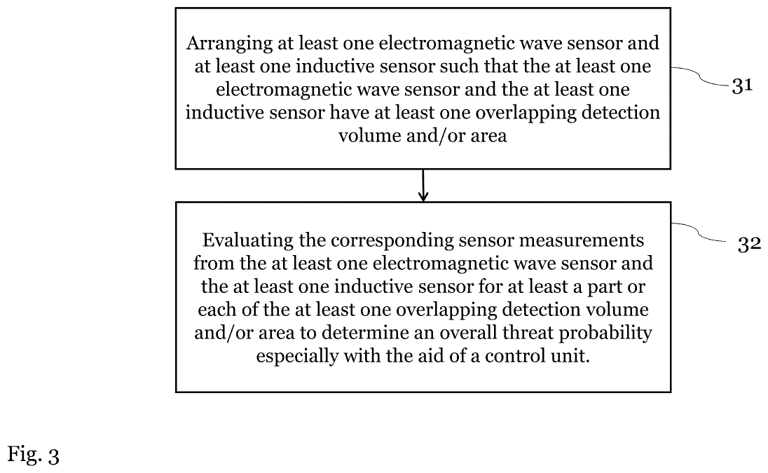

Finally, FIG. 3 illustrates a flow chart of an exemplary embodiment of the method for shoe and/or foot scanning according to the second aspect of the present disclosure, said method combining electromagnetic wave and inductive scanning capabilities.

In accordance with said FIG. 3, a first step 31 comprises arranging at least one electromagnetic wave sensor, such as the above-mentioned electromagnetic wave sensor field 11 of FIG. 1, and at least one inductive sensor, such as the above-mentioned inductive sensor field 12 of FIG. 1, such that the at least one electromagnetic wave sensor and the at least one inductive sensor have at least one overlapping detection volume and/or area.

In addition to this, a second step 32 comprises evaluating the corresponding sensor measurements from the at least one electromagnetic wave sensor and the at least one inductive sensor for at least a part or each of the at least one overlapping detection volume and/or area to determine an overall threat probability especially with the aid of a control unit such as the above-mentioned control unit 13 according to FIG. 1.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above-described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A shoe and/or foot scanner combining electromagnetic wave and inductive scanning capabilities, comprising:
at least one electromagnetic wave sensor,
at least one inductive sensor, and
a control unit,
wherein the at least one electromagnetic wave sensor and the at least one inductive sensor are arranged such that the at least one electromagnetic wave sensor and the at least one inductive sensor have at least one overlapping detection volume and/or area, and
wherein the control unit is configured to evaluate the corresponding sensor measurements from the at least one electromagnetic wave sensor and the at least one inductive sensor for at least a part or each of the at least one overlapping detection volume and/or area to determine an overall threat probability.

2. The shoe and/or foot scanner according to claim 1,
wherein the control unit is configured to decide whether there is an alarm to be reported based on the overall threat probability.

3. The shoe and/or foot scanner according to claim 1,
wherein the control unit is configured to determine at least one individual threat probability based on the corresponding sensor measurements from the at least one electromagnetic wave sensor.

4. The shoe and/or foot scanner according to claim 1,
wherein the control unit is configured to determine at least one further individual threat probability based on the corresponding sensor measurements from the at least one inductive sensor.

5. The shoe and/or foot scanner according to claim 3,
wherein if at least a part or each of the at least one individual threat probability is inconclusive, the control unit is configured to combine at least the part or each of the at least one individual threat probability with at least a part or each of at least one further individual threat probability based on the corresponding sensor measurements from the at least one inductive sensor especially to get at least one conclusive threat probability.

6. The shoe and/or foot scanner according to claim 4,
wherein if at least a part or each of the at least one further individual threat probability is inconclusive, the control unit is configured to combine at least the part or each of the at least one further individual threat probability with at least a part or each of at least one individual threat probability based on the corresponding sensor measurements from the at least one electromagnetic wave sensor especially to get at least one further conclusive threat probability.

7. The shoe and/or foot scanner according to claim 1,
wherein the control unit is configured to use machine learning and/or artificial intelligence and/or at least one artificial neural network to identify the correspondingly scanned object and/or materials especially based on the corresponding sensor measurements from the at least one electromagnetic wave sensor and/or the at least one inductive sensor.

8. The shoe and/or foot scanner according to claim 1,
wherein the control unit is configured to infer an amount of metal and/or shape with respect to the correspondingly scanned object and/or materials especially based on the corresponding sensor measurements from the at least one electromagnetic wave sensor and/or the at least one inductive sensor.

9. The shoe and/or foot scanner according to claim 8,
wherein the control unit is configured to correlate the amount of metal and shape with respect to the correspondingly scanned object and/or materials especially by using machine learning and/or artificial intelligence and/or at least one artificial neural network preferably to identify the correspondingly scanned object and/or materials.

10. The shoe and/or foot scanner according to claim 1,
wherein at least a part or each of the at least one electromagnetic wave sensor comprises or is at least one millimeter-wave transceiver, and/or
wherein at least a part or all of the at least one electromagnetic wave sensor forms a millimeter-wave transceiver array or a millimeter-wave panel.

11. The shoe and/or foot scanner according to claim 1,
wherein at least a part or each of the at least one inductive sensor comprises or is at least one coil, especially at least one metal detection coil.

12. The shoe and/or foot scanner according to claim 1,
wherein the control unit comprises or is a controller or an application-specific integrated circuit, especially an application-specific integrated circuit acquisition unit.

13. The shoe and/or foot scanner according to claim 1,
wherein the shoe and/or foot scanner is used in the context of security areas such as airport security.

14. A method for shoe and/or foot scanning, the method combining electromagnetic wave and inductive scanning capabilities and comprising the steps of:
arranging at least one electromagnetic wave sensor and at least one inductive sensor such that the at least one electromagnetic wave sensor and the at least one inductive sensor have at least one overlapping detection volume and/or area, and
evaluating the corresponding sensor measurements from the at least one electromagnetic wave sensor and the at least one inductive sensor for at least a part or each of the at least one overlapping detection volume and/or area to determine an overall threat probability especially with the aid of a control unit.

15. The method according to claim 14,
wherein the method further comprises the step of:
deciding whether there is an alarm to be reported based on the overall threat probability especially with the aid of the control unit.

16. The method according to claim 14,
wherein the method further comprises the step of:
determining at least one individual threat probability based on the corresponding sensor measurements from the at least one electromagnetic wave sensor especially with the aid of the control unit.

17. The method according to claim 14,
wherein the method further comprises the step of:
determining at least one further individual threat probability based on the corresponding sensor measurements from the at least one inductive sensor especially with the aid of the control unit.

18. The method according to claim 16,
wherein the method further comprises the step of:
if at least a part or each of the at least one individual threat probability is inconclusive, preferably with the aid of the control unit, combining at least the part or each of the at least one individual threat probability with at least a part or each of at least one further individual threat probability based on the corresponding sensor measurements from the at least one inductive sensor especially to get at least one conclusive threat probability.

19. The method according to claim 17,
wherein the method further comprises the step of:
if at least a part or each of the at least one further individual threat probability is inconclusive, preferably with the aid of the control unit, combining at least the part or each of the at least one further individual threat probability with at least a part or each of at least one individual threat probability based on the corresponding sensor measurements from the at least one electromagnetic wave sensor especially to get at least one further conclusive threat probability.

20. The method according to claim 14,
wherein the method further comprises the step of:
preferably with the aid of the control unit, using machine learning and/or artificial intelligence and/or at least one artificial neural network to identify the correspondingly scanned object and/or materials especially based on the corresponding sensor measurements from the at least one electromagnetic wave sensor and/or the at least one inductive sensor.
